(19) United States
(12) Patent Application Publication
(10) Pub. No.: US 2018/0336604 A1
(43) Pub. Date: Nov. 22, 2018

(54) DEVICE MANAGEMENT APPARATUS, NON-TRANSITORY COMPUTER READABLE STORAGE MEDIUM, AND DEVICE MANAGEMENT METHOD SUITABLE FOR COLLECTING DEVICE DATA

(71) Applicant: KYOCERA Document Solutions Inc., Osaka (JP)

(72) Inventor: Naoki KUWASAKI, Osaka (JP)

(73) Assignee: KYOCERA Document Solutions Inc., Osaka (JP)

(21) Appl. No.: 15/982,917

(22) Filed: May 17, 2018

(30) Foreign Application Priority Data
May 17, 2017 (JP) 2017-098066

(51) Int. Cl. G06Q 30/04; G06N 5/02

(52) U.S. Cl. CPC G06Q 30/04; G06N 5/022

(57) ABSTRACT

Provided is a device management apparatus that does not require re-acquiring cumulative data necessary for billing processing, and reliably executes billing processing of a corresponding month. A billing-information-management unit, based on billing-counter information having cumulative data that is received from a MFP, updates registered information in a billing-management table that includes updated data that is updated based on the cumulative data. Then, a system-control unit, when registered information is not registered in the billing-management table by a final closing date, causes the billing-information-management unit to update registered information in the billing-management table based on predicted data.

### INCORPORATION BY REFERENCE

This application is based on and claims the benefit of priority from Japanese Patent Application No. 2017-098066 filed on May 17, 2017, the contents of which are hereby incorporated by reference.

### BACKGROUND

The present disclosure relates to a device management apparatus, a non-transitory computer readable storage medium, and a device management method suitable for collecting device data.

An image forming apparatus, which is one device, is provided with various life counters for measuring the degree of consumption and the like of consumables (various rollers and the like), billing counters for counting the number of sheets used of each size and type of paper used, and the like. The image forming apparatus may be, for example, an MFP Multifunction Peripheral) such as a multifunction printer, combination device and the like. Moreover, the image forming apparatus is managed by a device management server that is connected via a network such as the Internet and the like. The device management server periodically acquires from the image forming apparatus, status counter information by various life counters for measuring the degree of consumption and the like of consumables (various rollers and the like) and device information that includes billing counter information by billing counters, and the like. Periodically, may be, for example, once a day (for example 17:00). In addition, the device management server manages the state of the image forming apparatus based on status counter information and the like, and manages billing counter information necessary for billing processing.

Incidentally, when the image forming apparatus is offline or for some reason the device management server cannot connect to the image forming apparatus, it may not be possible for the device management server to acquire device information, including billing-counter information, from the image forming apparatus. In this case, billing-counter information that is necessary for the billing processing for that month's billing cannot be acquired, so accurate billing processing cannot be performed.

In typical technology, in order to solve this kind of problem, devices for which the usage amounts of consumables are to be checked are extracted based on the contract IDs. Then, a deadline for checking the usage amount of consumables for each extracted device is acquired. Next, by referring to a log that records the usage amount of consumables, whether or not there is a checking date on which checking of the usage amount by the deadline is complete is checked. When there is no checking date in the log, there is a usage amount acquiring apparatus that changes the procedure for checking the usage amount according to the priority data specified by the contract ID.

### SUMMARY

A device management apparatus according to the present disclosure includes a billing-information-management unit and a system-control unit. The billing-information-management unit, based on billing-counter information having cumulative data that is received from a device, updates registered information in a billing-management table that includes updated information that is updated based on the cumulative data. The system-control unit, when registered information is not registered in the billing-management table by a final closing date, causes the billing-information-management unit to update registered information in the billing-management table based on predicted data.

A non-transitory computer readable recording medium according to the present disclosure stores a device-management program that can be executed by a computer of a device management apparatus. When the computer executes the device-management program, the computer, by a billing-information-management unit, based on billing-counter information having cumulative data that is received from a device, updates registered information in a billing-management table that includes updated data that is updated based on the cumulative data. Then, the computer, by a system-control unit, when registered information is not registered in the billing-management table by a final closing date, causes the billing-information-management unit to update registered information in the billing-management table based on predicted data.

The device management method according to the present disclosure has a step wherein a billing-information management unit, based on billing-counter information having cumulative data that is received from a device, updates registered information in a billing-management table that includes updated data that is updated based on the cumulative data. Moreover, the device management method according to the present disclosure has a step wherein a system-control unit, when registered information is not registered in the billing-management table by a final closing date, causes the billing-information-management unit to update registered information in the billing-management table based on predicted data.

### BRIEF DESCRIPTION OF THE DRAWINGS

FIG. 1 illustrates configuration of a device management system according to an embodiment of a device management apparatus of the present disclosure.

FIG. 2 illustrates an example of configuration of the device management server, the management terminal and a MFP in FIG. 1.

FIG. 3A illustrates information that is managed by the device management server in FIG. 1, and illustrates an example of a billing-management table for a corresponding month managed by the device management server.

FIG. 3B illustrates information that is managed by the device management server in FIG. 1, and illustrates past registered information in a billing-management table managed by the device management server.

FIG. 4 illustrates an example of billing-counter information that is transmitted by an MFP in FIG. 1.

FIG. 5 is a flowchart for explaining a MFP management method by the device management server in FIG. 1.

### DETAILED DESCRIPTION

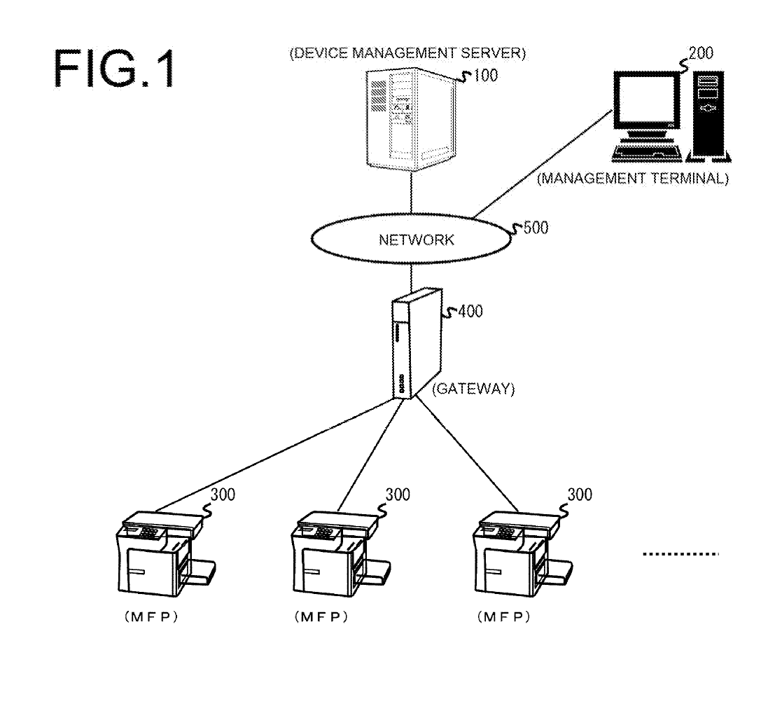

An embodiment of a device management apparatus according to the present disclosure will be explained below with reference to FIG. 1 to FIG. 5. It should be noted that in the explanation below, an MFP (Multifunction Peripheral), which is a combination peripheral device, is used as an example of a device that is managed by a device management apparatus. The MFP may be provided, for example, with a printing function, a copying function, a FAX function, a data transmitting/receiving function via a network, and the like.

First, as illustrated in FIG. 1, a device management server 100 as a device management apparatus is connected to a management terminal 200 and a gateway 400 via a network 500 such as the Internet or the like. A plurality of MFPs 300 are connected to the gateway 400. Incidentally, the configuration is not limited to a plurality of MFPs 300, and there may be only a single MFP 300.

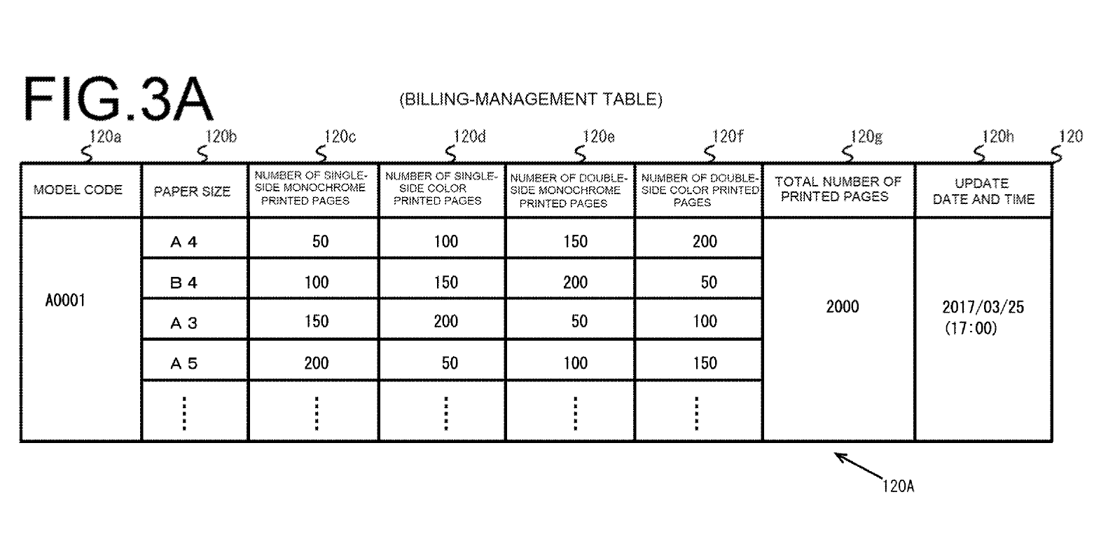

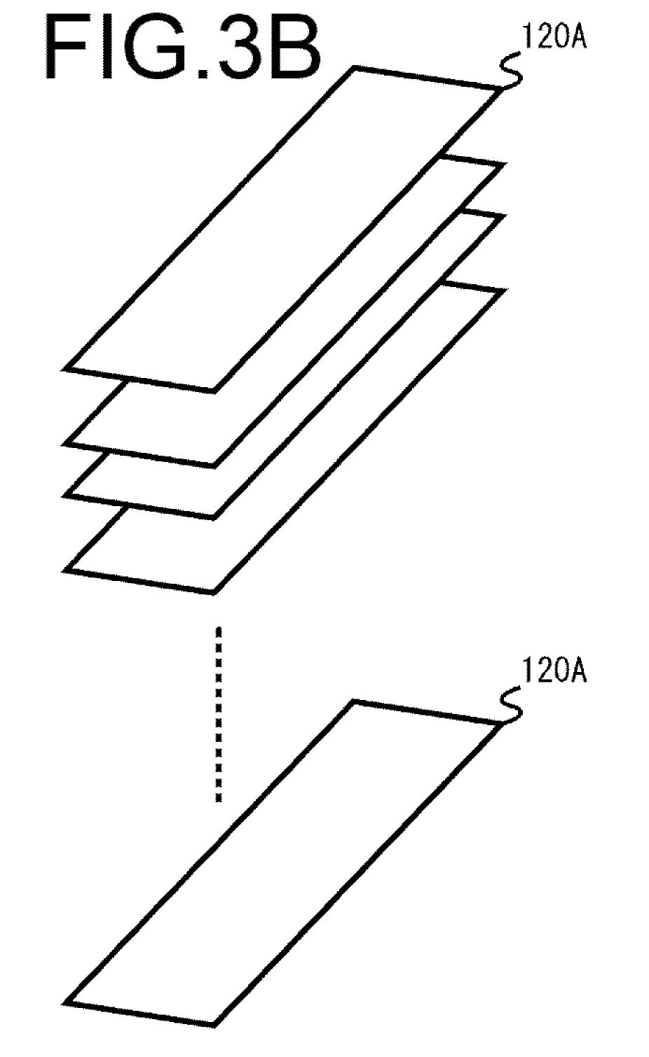

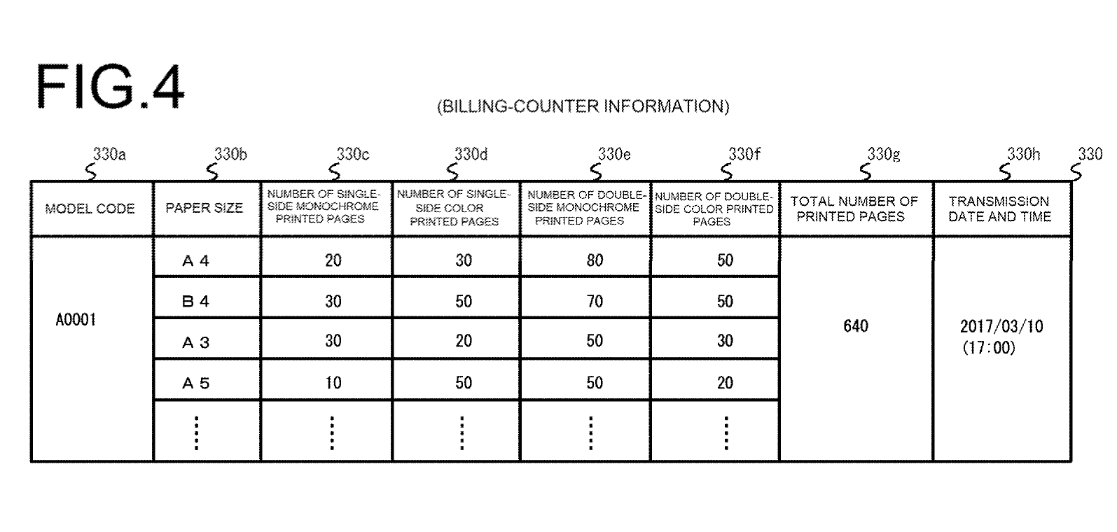

The device management server 100 periodically acquires from an MFP 300, status-counter information by various life counters that measure the degree of consumption and the like of consumables (various rollers and the like) and device information that includes billing-counter information 330 as illustrated in FIG. 4 described later by a billing counter, and the like. Periodically may be, for example, once a day (for example, 17:00). Then, the device management server 100 manages the state of the MFP 300 based on the status-counter information and the like, and updates registered information 120A that indicates registered contents in a billing-management table 120 as illustrated in FIG. 3A described later, for example, based on the billing-counter information 330. Incidentally, the device management server 100 manages a MFP 300 based on the model code in the item column 120a of the billing-management table 120 illustrated in FIG. 3A described later, for example. Moreover, the case will be explained in which the device management server 100 for some reason is not able to acquire the cumulative data of the billing-counter information 330 from an MFP 300 by a final closing date. The final closing date may be, for example, the twenty fifth of every month. In this case, the device management server 100, based on registered information 120A that indicates past registered contents of the billing-management table 120 illustrated in FIG. 3B described later, updates the registered information 120A in the billing-management table 120 illustrated in FIG. 3A described later. Incidentally, the device management server 100 will be described in detail later. The management terminal 200 generates billing information based on the registered information 120A in the billing-management table 120 illustrated in FIG. 3A described later that is managed by the device management server 100, and executes a billing process (arranges billing and the like). In addition, when the registered information 120A in the billing-management table 120 illustrated in FIG. 3A described later is based on predicted data, the management terminal 200 adjusts the difference during the next billing process. Furthermore, the management terminal 200 checks the status-counter information and the like that is included in the device information acquired by the device management server 100, for example, and monitors the state of the MFP 300 side.

An MFP 300, as will be described in detail later, includes various life counters for measuring the degree of consumption and the like of consumables (various rollers, and the like), a billing counter for counting the number of sheets used and the like for each size and type of paper used, and the like. In addition, the billing counter also counts usage and the like of any of the functions such as a printing function, copying function, FAX function, data transmitting/receiving function via a network, and the like. Moreover, the MFP 300 transmits status-counter information and device information to the device management server 100 based on a periodic request from the device management server 100. Periodic may be, for example, once a day (for example, 17:00). The status-counter information may be information by various life counters that measure the degree of consumption and the like of consumables (various rollers, and the like). The device information may include billing-counter information 330 by a billing counter as illustrated in FIG. 4 described later, and the like. The timing of the request from the device management server 100 can be changed arbitrarily. For example, the timing may be twice a day, or once every two days. Furthermore, the time is not limited to 17:00, and, for example, may be 8:00 or the like. The gateway 400 relays the transmission and reception of data between the device management server 100 and the MFP 300.

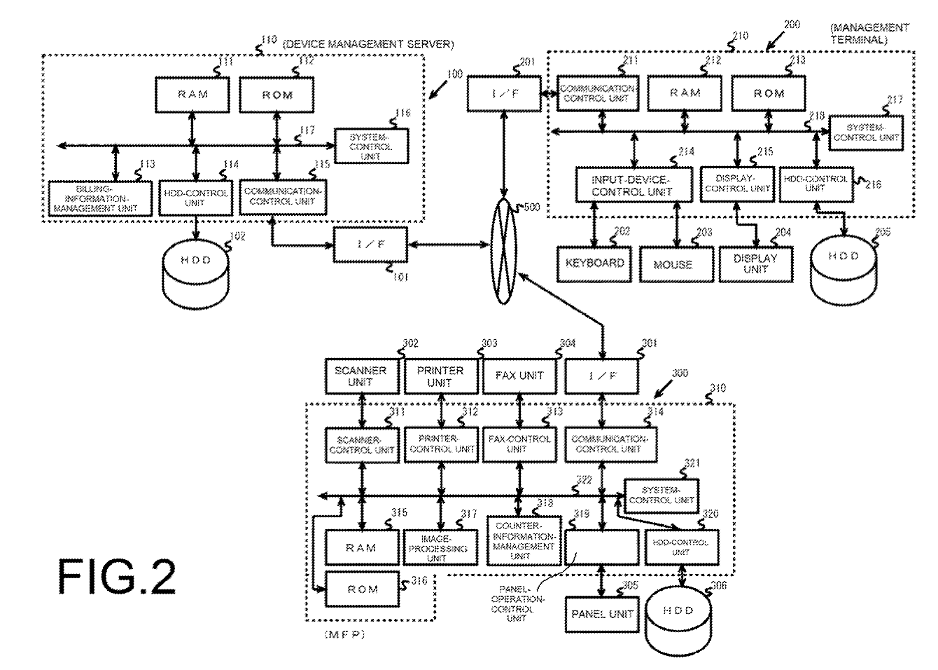

Next, an example of the configuration of the device management server 100, the management terminal 200 and an MFP 300 will be explained with reference to FIG. 2. First, the device management server 100 includes a control unit 110 that controls an I/F (interface) 101 and HDD (Hard Disk Drive) 102. The I/F 101 is in charge of communication with the management terminal 200, MPF 300 and the like via a network 500. The HDD 102 is a storage device that stores application programs, a billing-management table 120, registered information 120A, and the like. The application program may provide various functions of the device management server 100. A billing-management table 120 is illustrated in FIG. 3A described later. The registered information 120A may indicate past registered contents of the billing-management table 120 as illustrated in FIG. 3B described later.

The control unit 110 is a processor that controls the overall operation of the device management server 100 by executing application programs, control programs and the like. The control unit 110 includes RAM (Random Access Memory) 111, ROM (Read Only Memory) 112, a billing-information-management unit 113, a HDD control unit 114, a communication-control unit 115, and a system-control unit 116. In addition, these units are connected to a data bus 117. The RAM 111 is a work memory for executing programs. The ROM 112 stores a control program for performing an operation check and the like of each of the units. The billing-information-management unit 113 manages the billing-management table 120 illustrated in FIG. 3A described later, and updates registered information 120A in the billing-management table 120 based on billing-counter information 330 illustrated in FIG. 4 described later that is included in the device information from the MFP 300. More specifically, the billing-information-management unit 113 updates the registered information 120A by rewriting the registered information 120A to the counted value indicated in the billing-counter information. In addition, the billing-information-management unit 113 manages registered information 120A that indicates the past registered contents of the billing-management table 120 illustrated in FIG. 3B described later. The HDD control unit 114 controls reading, writing and the like of data to and from the HDD 102. The communication-control unit 115, via the I/F 101, performs control of transmission and reception of data and the like via the network 500. The system-control unit 116 periodically acquires from the MFP 300, status-counter information by various life counters that measure the degree of consumption and the like of consumables (various rollers and the like) and device information that includes billing-counter information 330 illustrated in FIG. 4 described later by a billing counter, and the like. Periodically may be, for example, once a day (for example, 17:00). Moreover, the case is explained in which, due to some reason, cumulative data of the billing-counter information 330 from the MFP 300 cannot be acquired by the final closing date. The final closing date, for example, may be the twenty fifth of every month. In this case, the system-control unit 116, for example, calculates average predicted data during a specified period from registered information 120A that indicates the past registered contents of the billing-management table 120 illustrated in FIG. 3B described later, and causes the billing-information-management unit 113 to update the registered information 120A of the billing-management table 120 illustrated in FIG. 3A described later of the corresponding month. Incidentally, this will be described in detail later. In addition, the case will be explained in which, for example, registered information 120A that indicates past registered contents of the billing-management table 120 illustrated in FIG. 3B described later is not stored in the HDD 102. In this case, the system-control unit 116 calculates predicted data based on a standard number of printed pages during a specified period (contract billing information) that is based on the billing contract with a customer registered in the billing-management table 120 illustrated in FIG. 3A described later. Then, the system-control unit 116 causes the billing-information-management unit 113 to update, for example, the registered information 120A of the billing-management table 120 illustrated in FIG. 3A described later of the corresponding month. Moreover, the case will be explained in which there is no contract with a customer related to the standard number of printed pages. In this case, for example, the system-control unit 116 calculates predicted data based on a specification value that is the average number of printed pages during a specified period that is based on the specifications stored in the HDD 102 for the target device. Then, the system-control unit 116 causes the billing-information-management unit 113 to update, for example, the registered information 120A of the billing-management table 120 illustrated in FIG. 3A described later of the corresponding month. In short, when, for some reason, it is not possible to acquire cumulative data of the billing-counter information 330 from the MFP 300 by the final closing date, the billing-information-management unit 113 updates the registered information 120A by adding predicted data to the registered information 120A. The final closing date may be, for example, the twenty fifth of every month. Here, the specified period, for example, is monthly. In the present embodiment, the “specified period” will hereinafter be explained as being monthly.

The management terminal 200 includes a control unit 210 that controls an I/F 201, a keyboard 202, a mouse 203, a display unit 204, and a HDD 205. The I/F 201 is in charge of communication with the device management server 100, the MFP 300 and the like via the network 500. The keyboard 202 is an input device for inputting characters and the like to the control unit 210. The mouse 203 is an input device for giving an instruction to the control unit 210 of an input position and the like. The display unit 204, for example, displays device information and the like that the device management server 100 receives from the MFP 300. The HDD 205 is a storage device that stores application programs and the like for providing the various functions of the management terminal 200.

The control unit 210 is a processor that controls the overall operation of the device management server 100 by executing application programs, control programs, and the like. The control unit 210 includes a communication-control unit 211, RAM 212, ROM 213, an input-device-control unit 214, a display-control unit 215, a HDD-control unit 216, and a system-control unit 217. In addition, these units are connected to a data bus 218. The communication-control unit 211, via the I/F 201, performs control of transmission and reception of data and the like via the network 500. The RAM 212 is a work memory for executing programs. The ROM 213 stores a control program for performing operation checks and the like for each unit. The input-device-control unit 214 controls the input operation of the keyboard 202 and mouse 203, and sends input signals of the keyboard 202 and mouse 203 to the control unit 210. The display-control unit 215 controls the display operation of the display unit 204. The HDD-control unit 216 controls reading, writing and the like of data to and from the HDD 205. The system-control unit 217, for example, acquires device information and the like that the device management server 100 receives from the MFP 300, and via the display-control unit 215, displays the device information on the display unit 204. Moreover, the system-control unit 217 references, for example, the registered information 120A in the billing-management table 120 illustrated in FIG. 3A described later of the corresponding month, and generates billing information that is necessary for the billing process. The billing-management table 120 may also be managed by the billing-information-management unit 113 of the device-management server 100.

The MFP 300 includes a control unit 310 that control the operation of an I/F 301, a scanner unit 302, a printer unit 303, a FAX unit 304, a panel unit 305 and a HDD 306. Moreover, the MFP 300 includes various life counters for measuring the degree of consumption and the like of consumables (various rollers and the like), a billing counter for counting the number of sheets and the like for each size and type of paper that is used, and the like. The I/F 301 is in charge of communication with the device management server 100, management terminal 200 and the like via the network 500. In addition, the I/F 301 is in charge of communication with other MFPs 300, user terminals and the like. Incidentally, the I/F 301 may also be in charge of communication with a content sever, web server and the like via the network 500. The scanner unit 302 is a device that reads a document image by an image sensor, converts the document image into digital image data, and inputs the digital image data to the control unit 310. The printer unit 303 is a device that prints an image onto paper based on printing data that is outputted from the control unit 310. The FAX unit 304 is a device that transmits data outputted from the control unit 310 to a facsimile of another party via telephone lines, and also receives data from a facsimile of another party and inputs that data to the control unit 310. The panel unit 305 is a device such as a touch panel or the like for performing a display for the printing function, copying function, FAX function, data transmission/reception function via a network, and various settings of the MFP 300. The HDD 306 is a storage device that stores application programs and the like for providing various functions of the MFP 300. Moreover, the HDD 306 has, for example, user boxes that store printing jobs that are registered from a user terminal.

The control unit 310 is a processor that controls the overall operation of the MFP 300 by executing application programs such as for a printing function, copying function, FAX function, data transmission/reception function via a network and the like, an image forming program, a control program and the like. The control unit 310 includes a scanner-control unit 311, a printer-control unit 312, a FAX (Facsimile)-control unit 313, a communication-control unit 314, RAM 315, ROM 316, an image-processing unit 317, a counter-information-management unit 318, a panel-operation-control unit 319, a HDD-control unit 320, and a system-control unit 321. Moreover, these units are connected to a data bus 322.

The scanner-control unit 311 controls the reading operation of the scanner unit 302. The printer-control unit 312 controls the printing operation of the printer unit 303. The FAX-control unit 313 controls the data transmission/reception operation by the FAX unit 304. The communication-control unit 314, via the I/F 301, performs control of transmission and reception of data and the like via the network 500.

The RAM 315 is a work memory for executing programs. Moreover, the RAM 315 stores printing data that has undergone image processing by the image-processing unit 317. The ROM 316 stores a control program for performing operation checks and the like of each of the units. The image-processing unit 317 performs image processing (rasterization) of image data that is read by the scanner unit 302. In addition, the image-processing unit 317 performs image processing (rasterization) of printing jobs that are registered in user boxes in the HDD 306. Incidentally, the system-control unit 321 temporarily stores printing data that has undergone image processing by the image-processing unit 317 in the RAM 315.

The counter-information-management unit 318 manages status-counter information by various life counters that measure the degree of consumption and the like of consumables (various rollers and the like) and device information that includes billing-counter information 330 illustrated in FIG. 4 described later by a billing counter, and the like. The panel-operation-control unit 319 controls the display operation of the panel unit 305. Moreover, the panel-operation-control unit 319, via the panel unit 305, receives settings and the like for starting printing, copying, a FAX, data transmission/reception via a network, and the like. The HDD-control unit 320 controls reading, writing and the like of data to and from the HDD 306. The system-control unit 321 controls linked operation and the like of each of the units. In addition, the system-control unit 321, according to a periodic request from the device management server 100, for example, transmits status-counter information and device information to the device management server 100 via the communication-control unit 314. Periodic may be, for example, once a day (for example, 17:00). The status-counter information may also be managed by the counter-information-management unit 318. The device information may also include billing-counter information 330.

Next, information that is managed by the device management server 100 side will be explained with reference to FIG. 3A and FIG. 3B. First, FIG. 3A illustrates an example of a billing-management table 120 for the corresponding month that is managed by the billing-information-management unit 113. Moreover, FIG. 3B illustrates registered information 120A that indicates past registered contents of the billing-management table 120. Incidentally, for convenience, the registered information 120A of the billing-management table 120 illustrated in FIG. 3A is only for the number of printed sheets of paper that are the target of billing. The billing-management table 120 illustrated in FIG. 3A is provided with an item column 120a, an item column 120b, an item column 120c, an item column 120d, an item column 120e, an item column 120f, an item column 120g and an item column 120h. The item column 120a indicates, for example, the model code, which is the content of the registered information 120A. The item column 120b indicates paper sizes. The item column 120c indicates the number of single-side monochrome printed pages. The item column 120d indicates the number of single-side color printed pages. The item column 120e indicates the number of double-side monochrome printed pages. The item column 120f indicates the number of double-side color printed pages. The item column 120g indicates the total number of printed pages. The item column 120h indicates the update date and time.

The model code in the item column 120a is identification information for managing the MFP 300. Incidentally, connection information of the MFP 300 is linked to the model code. The paper sizes in the item column 120b indicate the sizes of paper used on the MFP 300 side. The number of single-side monochrome printed pages in the item column 120c indicates the updated data of the number of pages printed in monochrome on a single side for each paper size in the item column 120b. The number of single-side color printed pages in the item column 120d indicates the updated data of the number of pages printed in color on a single side for each paper size in the item column 120b. The number of double-side monochrome printed pages in the item column 120e indicates the updated data of the number of pages printed in monochrome on both sides for each paper size in the item column 120b. The number of double-side color printed pages in the item column 120f indicates the updated data of the number of pages printed in color on both sides for each paper size in the item column 120b. The total number of printed pages in the item column 120g indicates updated data for the total number of the printed pages in the item columns 120c to 120f. The update date and time in the item column 120h illustrates updated data for the date and time when the registered information 120A in the billing-management table 120 is updated based on billing-counter information 330 in FIG. 4 described later that is included in the device information acquired periodically from the MFP 300. Periodically may be, for example, once a day (for example, 17:00). It should be noted, that for the convenience of explanation, it is presumed that during the update date and time (17:00) there is no time lag with respect to the time (17:00) at which device information is acquired from the MFP 300. In addition, the monthly standard number of printed pages based on the billing contract with the customer (contract billing information) may be registered in the billing-management table 120. Moreover, the monthly standard number of printed pages based on the billing contract with the customer (contract billing information) may be stored in the HDD 102.

Here, the case will be explained in which, due to some reason, cumulative data of the billing-counter information 330 illustrated in FIG. 4 described later cannot be acquired from the MFP 300 by the final closing date. The final closing date may be, for example, the twenty fifth of every month. In this case, the system-control unit 116, as described above, calculates monthly average predicted data from the registered data 120A that indicates the past registered contents of the billing-management table 120 in FIG. 3B, and causes the billing-information-management unit 113 to update the registered information 120A in the billing-management table 120 for the corresponding month. Moreover, the case will be explained in which the registered information 120A that indicates the past registered contents of the billing-management unit 120 illustrated in FIG. 3B is not stored in the HDD 102. In this case, as described above, the system-control unit 116 calculates predicted data based on the monthly standard number of printed pages based on the billing contract with the customer (contract billing information) that is registered in the billing-management table 120 illustrated in FIG. 3A of the corresponding month. Then, the system-control unit 116 causes the billing-information-management unit 113 to update the registered information 120A in the billing-management table 120 illustrated in FIG. 3A of the corresponding month. Furthermore, the case will be explained in which there is no contract with the customer related to the standard number of printed pages. In this case, the system-control unit 116, as described above, calculates predicted data based on a specification value as the monthly average number of printed pages based on the specifications for the target device stored in the HDD 102, and causes the billing-information-management unit 113 to update the registered information 120A in the billing-management table 120 illustrated in FIG. 3A of the corresponding month.

Next, an example of the billing-counter information 330 that is managed by the counter-information-management unit 318 of the MFP 300 will be explained with reference to FIG. 4. Incidentally, the contents of the billing-counter information 330 are transmitted by the MFP 300 according to a request from the device management server 100. Moreover, the case is illustrated in which the contents of the billing-counter information 330 are transmitted, for example, on the date Mar. 10, 2017 and at the time 17:00. In the billing-counter information 330, for example, data that corresponds to the item columns 330a to 330h below is written according to a specified format. In other words, the billing-counter information 330 is provided with an item column 330a, an item column 330b, an item column 330c, an item column 330d, an item column 330e, an item column 330f, an item column 330g and an item column 330h. The item column 330a indicates the model code. The item column 330b indicates paper sizes. The item column 330c indicates the number of single-side monochrome printed pages. The item column 330d indicates the number of single-side color printed pages. The item column 330e indicates the number of double-side monochrome printed pages. The item column 330f indicates the number of double-side color printed pages. The item column 330g indicates the total number of printed pages. The item column 330h indicates the transmission date and time. Each number of printed pages is a cumulative value for at least 2 months or more (when the specified period is monthly). The cumulative value may typically be a cumulative value from the start of using the MFP 300. However, this does not include the case in which the time is less than 2 months from the start of using the MFP 300.

Model code that is identification information for managing the MFP 300 is written in the item column 330a. Data indicating the paper sizes that can be used on the MFP 300 side are written in the item column 330b. Cumulative data of the number of pages printed in monochrome on a single side for each paper size is written in the item column 330c. Cumulative data of the number of pages printed in color on a single side for each paper size is written in the item column 330d. Cumulative data of the number of pages printed in monochrome on both side for each paper size is written in the item column 330e. Cumulative data of the number of pages printed in color on both sides for each paper size is written in the item column 330f. Cumulative data of the total number of printed pages indicating the total number of printed pages in the item columns 330c to 330f is written in item column 330g. Data of the transmission date and time when the billing-counter information 330 is transmitted according to a request from the device management server 100 is written in the item column 330h.

Here, on the device management server 100 side, billing-counter information 330 is received from the MFP 300 from the start of counting by the billing counter during the current billing and counting period until the date Mar. 10, 2017. However, it is presumed that after that, billing information is unable to be received due to some reason. In the present embodiment, the start of counting may be immediately after billing-counter information 330 is acquired on the final closing date of the previous month, and more specifically, immediately after 17:00 on the twenty fifth of the previous month. In this case, the registered information 120A up to immediately before 17:00 on the final closing date of the billing-management table 120 of the corresponding month in FIG. 3A is the content of the billing-counter information 330 on the date Mar. 10, 2017. The final closing date of the billing-counter table 120 on the corresponding month in FIG. 3A may be, for example, the twenty fifth of every month. The case is explained in which the date is not updated on the final closing date until immediately before 17:00 on the final closing date. The final closing date may be, for example, the twenty fifth of every month. In this case, the system-control unit 116 on the device management server 100 side, as described above, predicts the number of printed pages during a specified period. The system-control unit 116 causes the billing-information-management unit 113 to update the registered information 120A. The registered information 120A indicates the registered contents of the billing-management table 120 illustrated in FIG. 3A.

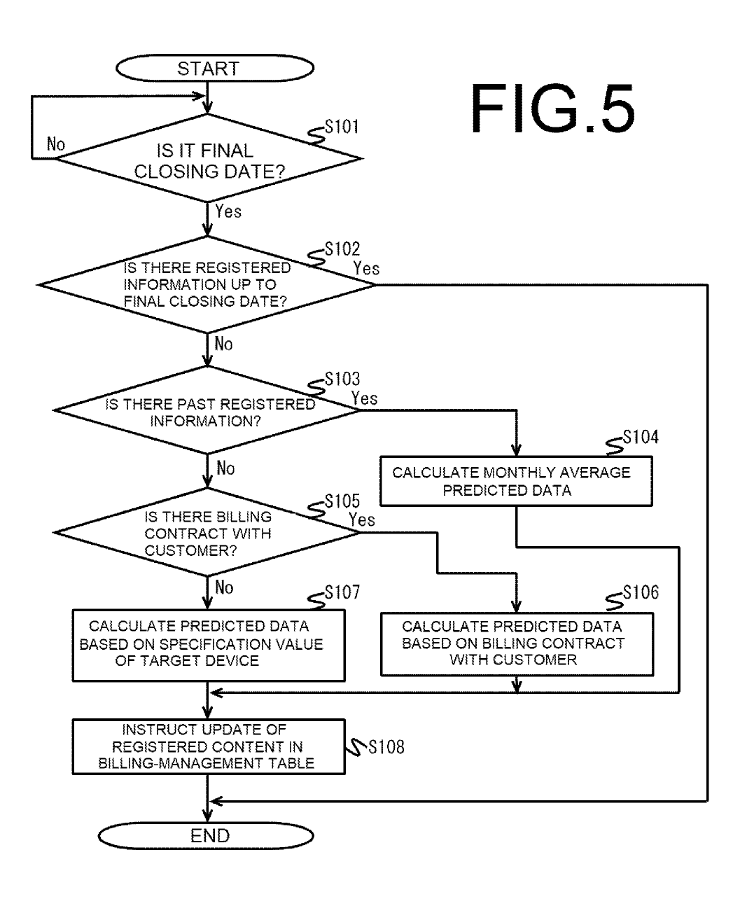

Next, the device management method by the device management server 100 will be explained with reference to FIG. 5. Incidentally, in the following, it is presumed that the system-control unit 116 of the device management server 100 determines the final closing date to be, for example, 17:00 on the twenty fifth.

### (Step S101)

The system-control unit 116 determines whether or not it is the final closing date.

In this case, the system-control unit 116 checks the date and time from the calendar and time counter, and when the time has not reached 17:00 on the twenty fifth, for example, determines that it is not the final closing date (step S101: NO).

On the other hand, the system-control unit 116 checks the date and time from the calendar and time counter, and when the time has reached 17:00 on the twenty fifth, for example, determines that it is the final closing date (step S101: YES). Processing then moves to step S102.

### (Step S102)

The system-control unit 116 determines whether or not there is registered information 120A up to the final closing date. More specifically, the system-control unit 116 determines whether or not there is registered information 120A at the end of counting by the billing counter during the current billing and counting period. In this embodiment, the end of the counting may be when billing-counter information 330 is acquired on the final closing date of the current month, or more specifically at 17:00 on the twenty fifth of the current month.

In this case, the system-control unit 116 checks the date and time in the item column 120h of the most recent registered information 120A in the billing-management table 120 of the corresponding month illustrated in FIG. 3A. Then, when the date and time matches the final closing date, the system-control unit 116 determines there is registered information 120A in the billing-management table 120 up to the final closing date (step S102: YES). Processing then ends.

On the other hand, the system-control unit 116 checks the date and time in the item column 120h in the billing-management table 120 of the corresponding month illustrated in FIG. 3A. Then, when the date and time does not match the final closing date, the system-control unit 116 determines there is no registered information 120A in the billing-management table 120 up to the final closing date (step S102: NO). Processing then moves to step S103.

### (Step S103)

The system-control unit 116 determines whether or not there is registered information 120A that indicates past registered contents of the billing-management table 120.

In this case, the system-control unit 116 accesses the HDD 102, and when registered information 120A indicating past registered contents of the billing-management table 120 can be confirmed, determines that there is registered information 120A indicating registered contents of the billing-management table 120 (step S103: YES). Processing then moves to step S104.

On the other hand, the system-control unit 116 accesses the HDD 102, and when registered information 120A indicating past registered contents of the billing-management table 120 cannot be confirmed, determines that there is no registered information 120A indicating registered contents of the billing-management table 120 (step S103: NO). Processing then moves to step S105.

### (Step S104)

The system-control unit 116 calculates monthly average predicted data.

In this case, the system-control unit 116 calculates monthly average predicted data from the registered information 120A that indicates past registered contents of the billing-management table 120 in FIG. 3B. Here, the system-control unit 116, for example, calculates predicted data based on the registered information 120A on the final closing date for a past specified number of times. More specifically, the system-control unit 116 calculates the average value of the number of printed pages during the billing and counting periods of the past specified number of times as the predicted data. Moreover, the system-control unit 116 may calculates predicted data based on registered information 120A that is updated during the current billing and counting period. More specifically, the system-control unit 116 may calculates predicted data by converting the average value of the difference in the number of printed pages for each update period of registered information 120A during the current billing and counting period to a monthly value. The average value above may be a simple average, or may be calculated by increasing the weighted count the closer the registered data 120A is to the current final closing date.

### (Step S105)

The system-control unit 116 determines whether or not there is a billing contract with a customer.

In this case, the system-control unit 116 references the billing-management table 120 in FIG. 3A, and when it is confirmed that a monthly standard number of printed pages based on a billing contract with a customer (contract billing information) is registered, determines that there is a billing contract with a customer (step S105: YES). Then processing moves to step S106.

On the other hand, the system-control unit 116 references the billing-management table 120 in FIG. 3A, and when it is confirmed that a monthly standard number of printed pages based on a billing contract with a customer (contract billing information) is not registered, determines that there is no billing contract with a customer (step S105: NO). Then processing moves to step S107.

### (Step S106)

The system-control unit 116 calculates predicted data based on the billing contract with a customer.

In this case, the system-control unit 116 calculates predicted data based on a monthly standard number of printed pages based on a billing contract with a customer (contract billing information).

### (Step S107)

The system-control unit 116 calculates predicted data based on a specification value of the target device.

In this case, the system-control unit 116 calculates predicted data based on a specification value, which is a monthly average number of printed pages based on the specifications of the target device.

### (Step S108)

The system-control unit 116 gives an instruction to update the registered contents of the billing-management table 120.

In this case, the system-control unit 116, in step S104, calculates the monthly average predicted data from the registered information 120A that indicates the past registered contents of the billing-management table 120 in FIG. 3B. When doing this, the system-control unit 116 causes the billing-management unit 113 to update the registered information 120A of the billing-management table 120 in FIG. 3A of the corresponding month based on the calculated monthly average predicted data.

Moreover, the system-control unit 116, in step S106 calculates predicted data based on a monthly standard number of printed pages based on a billing contract with the customer (contract billing information). When doing this, the system-control unit 116 causes the billing-information-management unit 113 to update the registered information 120A of the billing-management table 120 in FIG. 3A of the corresponding month based on predicted data that is based on a billing contract with the customer.

Furthermore, the system-control unit 116, in step S107, calculates predicted data based on a specification value, which is a monthly average number of printed pages that are based on the specifications of the target device. When doing this, the system-control unit 116 causes the billing-information-management unit 113 to update the registered information 120A in the billing-management table 120 in FIG. 3A of the corresponding month based on predicted data that is based on the specification value, which is a monthly average number of printed pages that are based on the specifications of the target device.

More specifically, the billing-information-management unit 113 updates the registered information 120A by adding the predicted data to the registered information 120A.

In this way, in this embodiment, the billing-information-management unit 113 updates registered information 120A in the billing-management table 120, which includes updated data that is updated based on cumulative data, based on billing-counter information 330 that has cumulative data received from the MFP 300 (device). Then, when registered information 120A is not registered in the billing-management table 120 up to the final closing date, the system-control unit 116 causes the billing-information-management unit 113 to update the registered information 120A in the billing-management table 120 based on predicted data.

In other words, the registered information 120A that is registered in the billing-management table 120 is updated based on cumulative data that is received from the MFP 300 (device). Therefore, the cumulative data that is received from the MFP 300 (device) includes newer contents than the registered information 120A that is registered in the billing-management table 120. Here, when for some reason cumulative data of the billing-counter information 330 cannot be acquired from the MFP 300 by the final closing date, the system-control unit 116 causes the billing-information-management unit 113 to calculate predicted data and update the registered information 120A in the billing-management table 120. The final closing date may be, for example, the twenty fifth of every month.

In this case, the system-control unit 116 is able to calculate predicted data from a monthly average of registered information 120A that indicates past registered contents of the billing-management table 120 that is stored in the HDD 102. Moreover, the case will be explained in which registered information 120A that indicates past registered contents is not registered in the HDD 102. In this case, the system-control unit 116 is able to calculate predicted data based on a monthly standard number of pages that is based on a billing contract with a customer that is registered in the billing-management table 120 (contract billing information). Furthermore, when there is no contract with a customer related to the monthly average number of printed pages, the system-control unit 116 is able to calculate predicted data based on a specification value, which is a monthly average number of printed pages based on specifications of the target device that are stored in the HDD 102.

In this way, even when registered information 120A up to the final closing date is not registered in the billing-management table 120, the registered information 120A in the billing-management table 120 can be updated based on predicted data. Therefore, not only is it unnecessary to re-acquire cumulative data that is necessary for the billing process, it is possible to reliably execute the billing process (arrange billing and the like) for the corresponding month.

Incidentally, the system-control unit 116 compares the registered information 120A in the billing-management table 120 that is updated on the final closing date during the current billing and counting period with the registered information 120A in the billing-management table 120 that is updated on the final closing date during the previous billing and counting period, and calculates the difference in each number of printed pages. Then, the system-control unit 116 may execute billing processing by calculating the billing amount of the current month based on the calculated difference in each number of printed pages. The final closing date of the current billing and counting period in this embodiment is the final closing date of the current month, and more specifically may be 17:00 on the twenty fifth of the current month. The final closing date of the previous billing and counting period in this embodiment is the final closing data of the previous month, and more specifically, may be 17:00 on the twenty fifth of the previous month.

Moreover, the order of steps S103 and S105 illustrated in FIG. 5 may be exchanged.

Furthermore, in this embodiment, the billing-management table and the billing-counter information indicate the number of printed pages, however, they could also indicate the number of printed surfaces or some other counted value.

In addition, in this embodiment, a MFP 300 is illustrated as an example of a device, however, the embodiment is not limited to this example, and, for example, the embodiment can be applied, for example, to another device such as a portable telephone, medical device, and the like that employ a pay-per-use lease form of usage.

In the typical usage amount acquiring apparatus described above, when checking the counter cannot be performed by the closing date, checking the counter is performed by switching to a counter checking method having higher priority by the final closing date, so it is possible to acquire the counter value within the corresponding month.

Incidentally, in this usage amount acquiring apparatus, CSS (Customer Support System) acquisition for which a first closing date is set, visit acquisition for which a second closing date is set, and counter check request for which a third closing date is set are set as the order of priority of the counter checking method. Here, the first method, CSS acquisition, is a method in which the counter value of a device is acquired via public lines. The second method, visit acquisition, is a method in which a checker that checks the counter visits the installation location of the device and acquires the counter value. The third method, counter check request, is a method in which a person in charge at the customer company is requested to perform a check of the counter by the third closing date.

Incidentally, the first to third counter check methods each differs from the checking process by the device management server in that checking by a checker is necessary, and there is a problem in that acquiring billing-counter information that is a counter value that is necessary for the billing process becomes complicated. Moreover, when it is not possible to acquire billing-counter information for the corresponding month by the final closing date, there is also a problem in that the billing process for the corresponding month (arranging billing and the like) cannot be executed.

With the device management apparatus, storage medium and device management method according to the present disclosure, even when registered information is not registered by the final closing date, registered information in a billing-management table can be updated based on predicted data. Therefore, not only is it unnecessary to re-acquire cumulative data required for billing processing, it is possible to reliably execute billing processing (arranging billing and the like) for the corresponding month.

What is claimed is:

1. A device management apparatus, comprising:
a billing-information-management unit that, based on billing-counter information having cumulative data that is received from a device, updates registered information in a billing-management table that includes updated data that is updated based on the cumulative data; and
a system-control unit that, when registered information is not registered in the billing-management table by a final closing date, causes the billing-information-management unit to update registered information in the billing-management table based on predicted data.

2. The device management apparatus according to claim 1, further comprising
a storage device for storing registered information that indicates past registered contents of the billing-management table; wherein
the system-control unit calculates the predicted data for a specified period from the registered information that indicates the past registered contents.

3. The device management apparatus according to claim 1, wherein
contract billing information for a specified period that is based on a billing contract with a customer is registered in the billing-management table; and
the system-control unit calculates the predicted data for the specified period based on the contract billing information.

4. The device management apparatus according to claim 1, further comprising
a storage device for storing an average specification value for a specified period based on specifications of a target device; wherein
the system-control unit calculates the predicted data for the specified period from the specification value.

5. A non-transitory computer readable recording medium for storing a device-management program that can be executed by a computer of a device management apparatus; and when the computer executes the device-management program,
a billing-information-management unit, based on billing-counter information having cumulative data that is received from a device, updates registered information in a billing-management table that includes updated data that is updated based on the cumulative data; and
a system-control unit, when registered information is not registered in the billing-management table by a final closing date, causes the billing-information-management unit to update registered information in the billing-management table based on predicted data.

6. A device management method, comprising
a step wherein a billing-information management unit, based on billing-counter information having cumulative data that is received from a device, updates registered information in a billing-management table that includes updated data that is updated based on the cumulative data; and
a step wherein a system-control unit, when registered information is not registered in the billing-management table by a final closing date, causes the billing-information-management unit to update registered information in the billing-management table based on predicted data.
